(19) United States
(12) Patent Application Publication
(10) Pub. No.: US 2008/0128466 A1
(43) Pub. Date: Jun. 5, 2008

(54) Stapling Apparatus

(76) Inventors: Takao Hasegawa, Tokyo (JP); Katsunori Manabe, Tokyo (JP)

Correspondence Address: MORGAN LEWIS & BOCKIUS LLP, 1111 PENNSYLVANIA AVENUE NW, WASHINGTON, DC, 20004, US

(21) Appl. No.: 10/581,197

(22) PCT Filed: Dec. 3, 2004
(86) PCT No.: PCT/JP04/18018

§ 371 Date: Jun. 1, 2006

(30) Foreign Application Priority Data
Dec. 4, 2003 (JP) 2003-406407
Feb. 9, 2004 (JP) 2004-032661
Feb. 9, 2004 (JP) 2004 032662
Feb. 9, 2004 (JP) 2004-032663

(51) Int. Cl. B27F 7/30; B27F 7/17; B27F 7/38; B27F 7/00

(52) U.S. Cl. 227/117; 227/120; 227/136; 227/137

(57) ABSTRACT

With a feeding roller 42 being in contact with the peripheral face of a rolled staple 3 composed of a larger number of staples linearly coupled to form a roll shape, the feeding roller 24 is rotated by a driving motor and the rolled staple 3 is rotated in a roll-winding direction so that the tip of the rolled staple 3 is guided/supplied to a staple supplying path 100.

### TECHNICAL FIELD

The present invention relates to a stapling apparatus for stapling sheets to be stapled, installed on an image forming apparatus such as a copier.

### BACKGROUND ART

There is a previously known stapling apparatus for stapling a plurality of sheets incorporated in an image forming apparatus such as a copier.

There is also a previously known stapling apparatus in which a large number of straight staples linearly coupled is wound in a roll shape and housed in a cartridge (for example, JP-A-2000-167782). The rolled staple within the cartridge is discharged from the cartridge and guided/supplied to a staple supplying path. The rolled staple is further formed in a C-shape at the tip of the staple supplying path and driven out from a driver unit.

Meanwhile, in the above stapling apparatus, as a means for feeding the staple, a feeding claw which makes a reciprocating motion is adopted. However, in order to feed the rolled staple using the feeding claw, the tip side of the rolled staple must be flat. Further, in order to cause the feeding claw to make the reciprocating motion, the motion of a rotating motor must be changed into a linear operation. In addition, the feeding claw is difficult to be fed over a long distance as compared with a feeding roller.

Further, in the above feeding mechanism, a staple feeding device is laid out on a linear staple path. In order to feed the rolled staple to the staple feeding path, the staple must be designed in a consumable format with the tip pulled out from the outer edge of the rolled staple. Otherwise, the staple tip, after the rolled staple has been housed within the cartridge, must be fed to the staple feeding device.

However, in the case of the former, the management of the tip position during manufacture and the manufacture itself require time and labor, and are poor in productivity. The case of the latter requires the labor of a staple replacement operation and is poor in the operability.

In the stapling apparatus disclosed in JP-A-2000-167782, the feeding of the rolled staple is carried out by a plurality of plate-like stepping means which are linearly displaced. Owing to this, a long carrying path must be assured, which led to upsizing of the cartridge.

Further, in the stapling apparatus disclosed in JP-A-2000-167782, for example, where the forefront staple is buckled, the rolled staple corresponding several staples from the forefront staple must be pulled out to remove the buckled staple. However, in the stapling apparatus disclosed in JP-A-2000-167782, the rolled staple cannot be pulled back due to the provision of a non-return means. Thus, the several staples pulled out to remove the buckled staple, although they can be used, must be discarded.

Additionally, as seen from FIGS. 21(a) and 21(b), where the rolled staple is arranged at the rear lower portion of the cartridge, its tip is pulled from the upper side of the rolled staple. So a bonding sheet of the rolled staple is located between the staple and a binding sheet so that the good appearance is kept. However, a stapling mechanism such as a driver must be arranged in front of the rolled staple. Correspondingly, the feeding mechanism must be arranged above the rolled staple so that attachment/detachment of the rolled staple 3 must be carried out in a single direction of the rear.

Further, as seen from FIGS. 22(a) and 22(b), where the rolled staple 3 is arranged at the rear upper portion of the cartridge, attachment/detachment of the rolled staple 3 can be carried out in two directions of the top and the rear. However, since the direction of pulling out the tip of the rolled staple 3 is set at the lower side thereof. The bonding sheet W of the rolled staple 3 is located outside the staple S so that the appearance will be injured.

In order to obviate such inconvenience, as seen from FIG. 23, the rolled staple 3 is arranged at the rear upper portion of the cartridge and the direction of pulling out the tip of the rolled staple 3 is set at the upper side thereof. This, however, gives a curved portion in the feeding path of the rolled staple 3. Thus, the stepping means which gives a linear displacement as described above is difficult to avoid the upsizing of the staple feeding device.

As described above, since the arrangement relationship between the mechanism components and the rolled staple is related with the staple driving direction and the rolled staple loading direction, it was very difficult to realize both the downsizing and handling easiness.

Further, the stapling apparatus disclosed in JP-A-2000-167782 is so designed that while a motor 44 rotates in a normal direction, the stapling operation is carried out, and if the positional relationship related to the stapling operation is not normal, the motor is caused to rotate in a reverse direction and is restored to a normal position.

Therefore, the motor 44 has only a function of transmitting the same component forward or backward during the normal rotation or reverse rotation. In order to assure the force for the other function, another motor is required. This led to upsizing of the entire apparatus.

Further, the stapling operation requires great driving force, whereas the operating for the above position adjustment requires small driving force and may give great load.

Further, generally, an electric stapler adopts a structure in which a cartridge incorporating a large number of staples is replaceably attached/detached in/from an attachment space formed in an electric stapler body. As such a structure, there is a known structure as shown in FIGS. 24 and 25 in which a projection 126 formed at the lower side of the rear surface of a cartridge 125 is engaged with a locking pin 128 formed in the attachment space of the electric stapler body 127 so that it is mounted in the locked state. The locking pin 128 is urged by a spring 129. In this system, two operations of pulling out the cartridge 125 and canceling the engagement by the locking pin 128 in removing the cartridge 125 were carried out by a single operation of “picking up”. Therefore, on the way of pulling out the cartridge 125, peak load required for climbing over the locking pin 128 was instantaneously transmitted to the cartridge. So if a knob 130 of the cartridge 125 was not tightly grasped, the cartridge 125 might be dropped owing to slippage.

There is another known apparatus having a structure in which the cartridge is attached or detached by engaging or disengaging an operating lever (for example, JP-A-10-180712 and JP-A-11-099505). However, in this structure, after the locking has been released by the operating lever, a hand is once moved off the operating lever and shifted to the cartridge. This takes time and labor. In addition, hand's shifting may be not successful according to the attaching angle of the apparatus so that the cartridge may fall. Thus, a mechanism for preventing the cartridge from falling must be provided, thus presenting a problem of increasing the load in pulling out the cartridge.

### DISCLOSURE OF THE INVENTION

### Problems that the Invention is to Solve

In order to solve the problem described above, an object of the present invention is to provide a stapling apparatus capable of surely guiding/supplying a rolled staple to a staple supplying path.

Further, in order to solve the problem described above, another object of the present invention is to provide a stapling apparatus capable of loading a cartridge from plural directions, giving good handling capability and also being downsized.

Further, in order to solve the problem described above, still another object of the present invention is to provide a stapling apparatus capable of easily switched into the driving for a different function using a single driving motor.

Further, in order to solve the problem described above, still another object of the present invention is to provide a stapling apparatus capable of switching between the driving force of a driving motor for a stapling operation requiring relatively great driving force and the driving force of the driving motor for the operation other than the stapling operation, only requiring relatively small driving force.

Further, in order to solve the problem described above, still another object of the present invention is to provide a stapling apparatus capable of carrying out a cartridge removing operation sequentially, easily and smoothly and of surely preventing the cartridge from falling.

### Means for Solving the Problems

In order to attain the above object, a rolled staple supplying mechanism according to embodiments of the present invention is characterized in that with a feeding roller being in contact with the outer surface of the rolled staple composed of a larger number of staples linearly coupled to form a roll shape, the feeding roller is rotated by a driving motor and the rolled staple is rotated in a pulling-out direction so that the tip of the rolled staple is guided/supplied to a staple supplying path.

A plurality of feeding teeth facing between adjacent staples of the rolled staple may be formed on the peripheral face of the feeing roller.

In accordance with the rolled staple supplying mechanism according the embodiments of the present invention, the rolled staple is composed of a larger number of staples linearly coupled to form a roll shape; the feeding roller in contact with the outer peripheral face of the rolled staple kept in the roll shape is rotated so that even when the tip of the rolled staple is located at any position, the tip of the rolled staple kept in the roll shape can be guided/supplied to a staple supplying path.

Therefore, management of the tip position of the rolled staple in manufacturing the cartridge and the manufacture itself do not time and labor, and good productivity is also given. Further, the guiding/supplying of the tip position of the rolled staple is automatically carried out so that staple replacement does not take labor and time and good operability and handling easiness are given.

Further, where the plurality of feeding teeth facing between adjacent staples of the rolled staple are formed on the peripheral face of the feeing roller, the rolled staple can be further surely fed by the feeding teeth.

Further, in a staple feeding apparatus according to embodiments of the present invention, a cartridge incorporates a rolled staple composed of a large number of staples linearly coupled on a bonding sheet and wound in a roll shape so that the bonding sheet is located outside, and the tip of the rolled staple is guided in a state curved so as to be wound back toward a side opposite to a roll-winding direction; and the cartridge is provided with a feeding claw swingably attached and engaged with a curved portion of the rolled staple to be guided in a carrying direction.

When the tip of the rolled staple is manually pulled out, the feeding claw is disengaged from the rolled staple so that the rolled staple may be pulled out.

In accordance with the staple feeding apparatus according to the embodiments of the present invention, a cartridge incorporates a rolled staple wound in a roll shape so that the bonding sheet is located outside, and the tip of the rolled staple is guided in a state curved so as to be wound back toward a side opposite to a roll-winding direction; and the cartridge is provided with a feeding claw swingably attached and engaged with a curved portion of the rolled staple to be guided in a carrying direction. In this construction, the cartridge can be loaded in a plurality of directions, and good handling and miniaturization can be realized.

Further, a stapling apparatus according to embodiments of the present invention is provided with: a driving motor rotatable in a normal and a reverse direction; a gear unit composed of a plurality of gears for transmitting the driving power of the driving motor; a switching gear located on the way of the gear unit, for driving its power transmission system into two systems; a first driving system for executing stapling by normal rotation driving of the driving motor when the switching gear is engaged with one power transmission system; and a second driving system for executing the operation other than the stapling by reverse rotation driving of the driving motor when the switching gear is engaged with the other power transmission system.

The stapling apparatus according to the embodiments of the present invention may includes a reference position detecting unit attached to the end of the first driving system so that only when the reference position detecting unit detects the reference position, the reverse rotation driving of the driving motor is continued.

The stapling apparatus according to the embodiments of the present invention may be realized in such a construction that one driving cycle of the first driving system is synchronous with the detecting timing of the reference position detecting unit; if the reference position detecting unit does not detect the reference position as a result that inconvenience occurs during the one driving cycle of the first driving system, the driving cycle of the first driving system is corrected so that when the reference position detecting unit detects the reference position, the driving motor can be driven in the reverse direction.

Further, driving torque may be made variable between during normal rotation and during reverse rotation of the driving motor.

The stapling apparatus may further include a detecting means for correcting the driving voltage value during the normal rotation or reverse rotation on the basis of two kinds of reference voltages for the normal rotation and reverse rotation of the driving motor.

The stapling apparatus may include two kinds of voltage supplying units of a high voltage supplying unit for the normal rotation of the driving motor; a low voltage supplying unit for the reverse rotation of the driving motor; and a selective switch for switching the supplying path according to the normal/reverse rotation of the driving motor.

The driving voltage of the driving motor may be switched by pulse width modulation.

In accordance with the above stapling apparatus according to the embodiments of the present invention, the driving power of the driving motor rotatable in a normal and a reverse direction is transmitted by a gear unit composed of a plurality of gears; through a switching gear located on the way of the gear unit to switch its power driving path into two directions, when one power transmission system and the first driving system are interlocked with each other, the driving motor is driven in the normal rotation to execute stapling and when the other power transmission and the second driving system through the switching gear, the driving motor is driven in the reverse rotation to execute the operation other than the stapling. Thus, the driving of the single driving motor can be easily switched to execute different functions. The second driving system includes automated loading of the staple, automated canceling of the cartridge, change in the stapler posture for staple replacement, and stapler movement.

In a cartridge attaching/detaching apparatus in an electric stapler in which a staple cartridge is intruded in an attachment space formed in an electric stapler body so as to be loaded by engagement between a locking piece formed in the attachment space and an engagement piece attached to the cartridge and removed by canceling the engagement, the cartridge is provided with a knob to be grasped in attaching or detaching; the engagement piece to be engaged with the locking piece in loading and an operating lever to be employed to cancel engagement between the engagement piece and the locking piece, and the knob and the operating lever are simultaneously grasped to cancel the engagement.

An operating link may be rotatably attached to an intermediate portion of the operating lever; and an engagement die may be rotatably attached to the tip of the operating link so that it is engaged with the locking piece when the operating lever is released.

In accordance with the stapling apparatus according to the embodiments of the present invention, there are provided a knob to be grasped in attaching or detaching of the cartridge; the engagement piece to be engaged with the locking piece in loading and an operating lever to be employed to cancel engagement between the engagement piece and the locking piece, and the knob and the operating lever are simultaneously grasped to cancel the engagement. Thus, the cartridge can be removed by simultaneously grasping the knob and the operating lever in removing by one hand. So the cartridge can be removed sequentially, easily and smoothly, thereby surely preventing the cartridge from falling.

Where the operating link is rotatably attached to an intermediate portion of the operating lever, and an engagement die is rotatably attached to the tip of the operating link so that it is engaged with the locking piece when the operating lever is released, by operating the operating lever, the engagement die can be engaged with or disengaged from the locking piece so that this operation very easily done by one hand.

### BRIEF DESCRIPTION OF THE DRAWINGS

FIG. 1 is a perspective view of the appearance of a stapling apparatus according to a first embodiment of the present invention.

FIG. 2 is a side view of the stapling apparatus.

FIG. 3 is a longitudinal sectional view of the stapling apparatus.

FIG. 4(a) is a view showing the construction of a power transmitting gear of the stapling apparatus and explaining the gear transmitting state during normal rotation.

FIG. 4(b) is a view showing the construction of a power transmitting gear of the stapling apparatus and for explaining the gear transmitting state during reverse rotation.

FIG. 5(a) is a perspective view of a staple supplying unit of the stapling apparatus.

FIG. 5(b) is a front view of a feeding roller of the stapling apparatus.

FIG. 5(c) is a view for explaining the relationship between the feeding roller of the stapling apparatus and staples.

FIG. 6(a) shows a staple supplying unit of the stapling apparatus in an initial state of the rolled staple supplying operation by the feeding roller.

FIG. 6(b) shows a staple supplying unit of the stapling apparatus in an intermediate state of the rolled staple supplying operation by the feeding roller.

FIG. 6(c) shows a staple supplying unit of the stapling apparatus in an ending state of the rolled staple supplying operation by the feeding roller.

FIG. 7(a) is a plan view of a cartridge.

FIG. 7(b) is a left side view of the cartridge.

FIG. 7(c) is a front view of the cartridge.

FIG. 7(d) is a right side view of the cartridge.

FIG. 8 is a longitudinal sectional view of the cartridge taken in line A-A in FIG. 7(a).

FIG. 9 is a longitudinal sectional view of the cartridge taken in line B-B in FIG. 7(a).

FIG. 10 is a longitudinal sectional view of the cartridge taken in line C-C in FIG. 7(a).

FIG. 11 is a longitudinal sectional view of the cartridge taken in line D-D in FIG. 7(a).

FIG. 12 is a longitudinal sectional view of the cartridge taken in line E-E in FIG. 7(a).

FIG. 13 is a perspective view of the main part of a feeding-out unit employed for the stapling apparatus using the cartridge.

FIG. 14(a) is a view for explaining the operation of a feeding-out unit employed for the stapling apparatus using the cartridge.

FIG. 14(b) is a view for explaining the operation of a feeding-out unit employed for the stapling apparatus using the cartridge.

FIG. 15(a) is a view for explaining the operation in taking out a staple in a feeding unit employed for the stapling apparatus using the cartridge.

FIG. 15(b) is a view for explaining the operation in taking out a staple in a feeding-out unit employed for the stapling apparatus using the cartridge.

FIG. 15(c) is a view for explaining the operation in taking out a staple in a feeding-out unit employed for the stapling apparatus using the cartridge.

FIG. 16(a) shows a circuit for making a motor driving torque variable between during normal rotation and reverse rotation in a normal/reverse driving motor by current limited value control.

FIG. 16(b) shows a circuit for making a motor driving torque variable between during normal rotation and reverse rotation in a normal/reverse driving motor by voltage switching.

FIG. 16(c) shows a circuit for making a motor driving torque variable between during normal rotation and reverse rotation in a normal/reverse driving motor by pulse width modulation.

FIG. 17 is an exploded side view of an electric stapler according to a second embodiment of the present invention.

FIG. 18 is a perspective view of the cartridge.

FIG. 19 is a view for explaining the loading or removing the cartridge.

FIG. 20 is a view for explaining the state where the cartridge has been loaded.

FIG. 21(a) is a view for explaining an example of the arrangement relationship of a rolled staple.

FIG. 21(b) is a view for explaining an example of the arrangement relationship of a rolled staple.

FIG. 22(a) is a view for explaining another example of the arrangement relationship of a rolled staple.

FIG. 22(b) is a view for explaining another example of the arrangement relationship of a rolled staple.

FIG. 23 is a view for explaining an ideal arrangement relationship of a rolled staple.

FIG. 24 is an exploded side view of conventional electric stapler.

FIG. 25 is a view for explaining a conventional cartridge attaching/detaching apparatus.

### DESCRIPTION OF REFERENCE NUMERALS AND SIGNS

A denotes a stapling apparatus; 2 a normal/reverse driving motor; 3 a rolled staple; 4 a bonding sheet; 11 a driving gear; 13 a following gear; 14 an interlocking gear; 16 a transmitting gear; 17 a transmitting/interlocking gear; 20 a switching gear; 22 a stopper gear; 24 a free gear; 26 an internal gear; 42 a feeding roller, 50 a cartridge; and 90 a feeding claw.

Further, 101 denotes a stapler body; 102 a cartridge; 110 an attaching area; 111 a locking piece; 115 a knob; 116 an operating lever; and 119 an engaging die.

### BEST MODE FOR CARRYING OUT THE INVENTION

Now referring to the drawings, an explanation will be given of the stapling apparatus according to the present invention.

### EMBODIMENT 1

### [Entire Configuration]

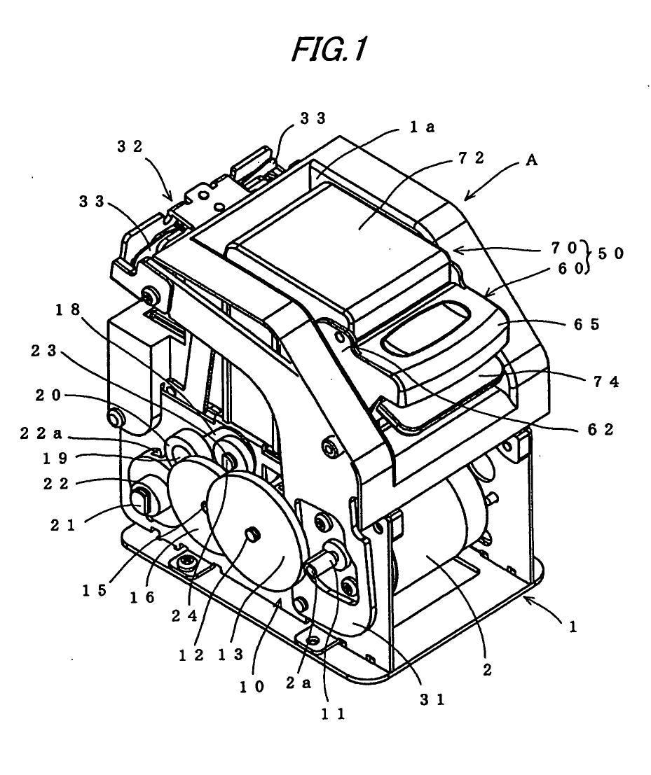

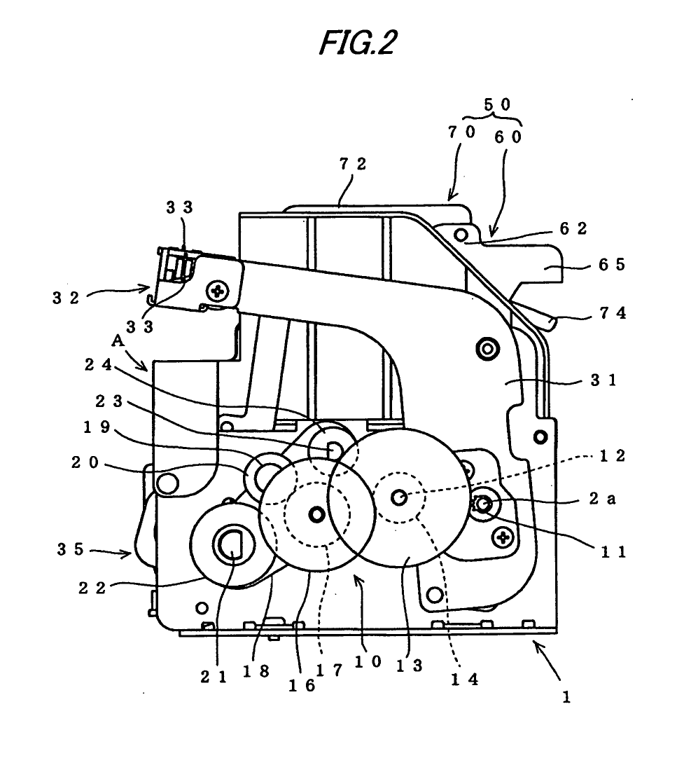

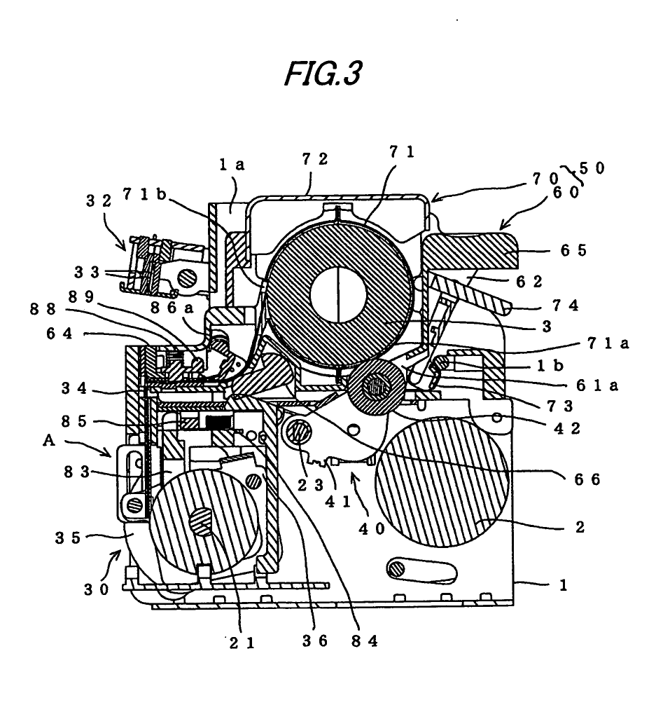

FIG. 1 is a perspective view of the appearance of a stapling apparatus according to a first embodiment of the present invention. FIG. 2 is a side view of the stapling apparatus. FIG. 3 is a longitudinal sectional view of the stapling apparatus.

Referring to FIGS. 1 to 3, a stapling apparatus A has a main frame 1 to be loaded in an image forming apparatus (not shown) in the meaning including a post-processing apparatus such as a sorter and finisher.

A normal/reverse driving motor 2 is fixed to the main frame 1. The main frame 1 includes a power transmission gear unit 10 for transmitting the rotary driving of the normal/reverse driving motor 2, a stapling unit 30 for performing a stapling operation while the normal/reverse driving motor 2 is in the normal rotation, a staple supplying unit 40 for performing a staple supplying operation while the normal/reverse driving motor 2 is in the reverse rotation, and a cartridge 50 detachably mounted in the main frame 1.

### [Power Transmission Gear Unit 10]

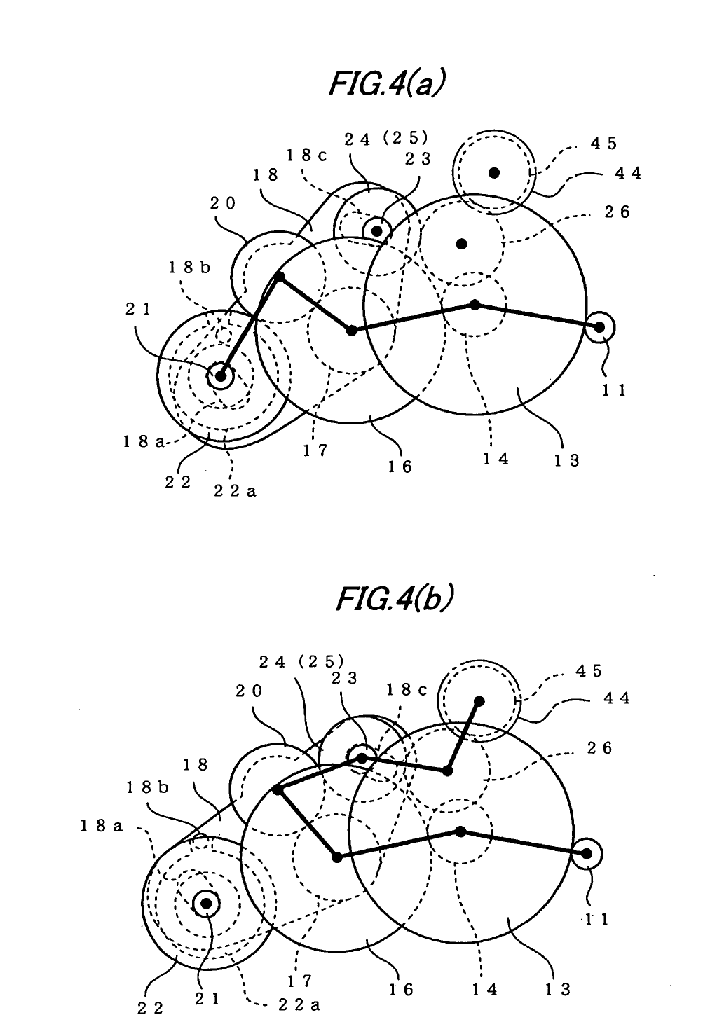

FIG. 4 shows the construction of the power transmission gear unit 10. FIG. 4(a) is a view for explaining the gear transmitting state during normal rotation. FIG. 4(b) is a view for explaining the gear transmitting state during reverse rotation.

The power transmission gear unit 10 includes a driving gear 11 fixed to an output 2a of a normal/reverse driving motor 2; a large-diameter following gear 13 rotatably held via a shaft 12 in the main frame 1 and in mesh with the driving gear 11; a small-diameter interlocking gear 14 attached to the shaft 12 inside the following gear 13; a large-diameter transmitting gear 16 rotatably held via a shaft 15 in the main frame 1 and in mesh with the following gear 14; a small-diameter transmitting/interlocking gear 17 attached to the shaft 15 inside the transmitting gear 16; a displacing gear 20 rotatably held via a shaft 19 on a rotating plate 18 (rotatably held at a rotating fulcrum of the shaft 15) and in mesh with the transmitting/interlocking gear 17; a stopper gear 22 rotatably held via a shaft 21 penetrating through the rotating plate 18 and normally in mesh with the displacing gear 20; a free gear 24 rotatably held via a shaft 23 penetrating through the rotating plate 18 and being free normally and meshing with the displacing gear 20 while the rotating plate 18 rotates in the reverse direction; an internal interlocking gear 25 located inside the main frame 1 and attached to the shaft 23; and an internal gear 26 located inside the main frame 1 so as to mesh with the internal interlocking gear 25.

The rotating plate 18 is formed of a thin metallic plate and has a long slot 18a through which the shaft 21 penetrates at the one end. In the vicinity of the long slot 18a, a projection 18b is protruded. The rotating plate 18 has a long slot 18c through which the shaft 23 penetrates at the other end. Thus, when the rotating plate 18 rotates, switching is made between the normal rotating state where the displacing gear 20 meshes with the stopper gear 22 as seen from FIG. 4(a) thereby to transmit the rotary driving of the driving gear 11 to the stopper gear 22 and the reverse rotating state where the displacing gear 20 meshes with the free gear 24 as seen from FIG. 4(b) thereby to transmit the rotary driving of the driving gear 11 to the internal gear 26. Incidentally, the rotary driving of the rotating plate 18 is not particularly limited as long as it can be limited at any timing by a clutch mechanism or solenoid attached to the rear surface of the main frame 1 and using the driving of the normal/reverse driving motor 2.

The stopper gear 22 has a protrusive guiding groove 22a formed on the rear surface. This protrusive guiding groove 22a is formed in a ring shape where the projection 18b is located so that rotation of the stopper gear 22 is permitted during the normal rotation where the displacing gear 20 is in mesh with the stopper gear 22. Further, the protrusive guiding groove 22a is formed to stop the rotation of the stopper gear 22 in such a manner that the projection 18b is displaced to a relief segment formed at a portion of the ring-shaped protrusive guiding groove 22a when switching is made to the reverse rotating state where the displacing gear 20 meshes with the free gear 24.

### [Stapling Unit 30]

The stapling unit 30 includes an arm 31 which rotates in a staple stapling operation; a clincher unit 32 attached to the upper end of the arm 31 and ascending/descending in interlock with the rotation of the arm 31; a driver 34 in opposition to a pair of clinchers 33 attached to the clincher unit 32 and ascending at a predetermined timing; and a driver driving plate 35 for causing the driver 34 to ascend/descend; and a timing plate 36 relatively non-rotatably attached to the shaft 21, which rotates simultaneously with the rotation of the stopper gear 22 thereby to drive the arm 31, clinchers 33 and driver driving plate 35.

### [Staple Supplying Unit 40]

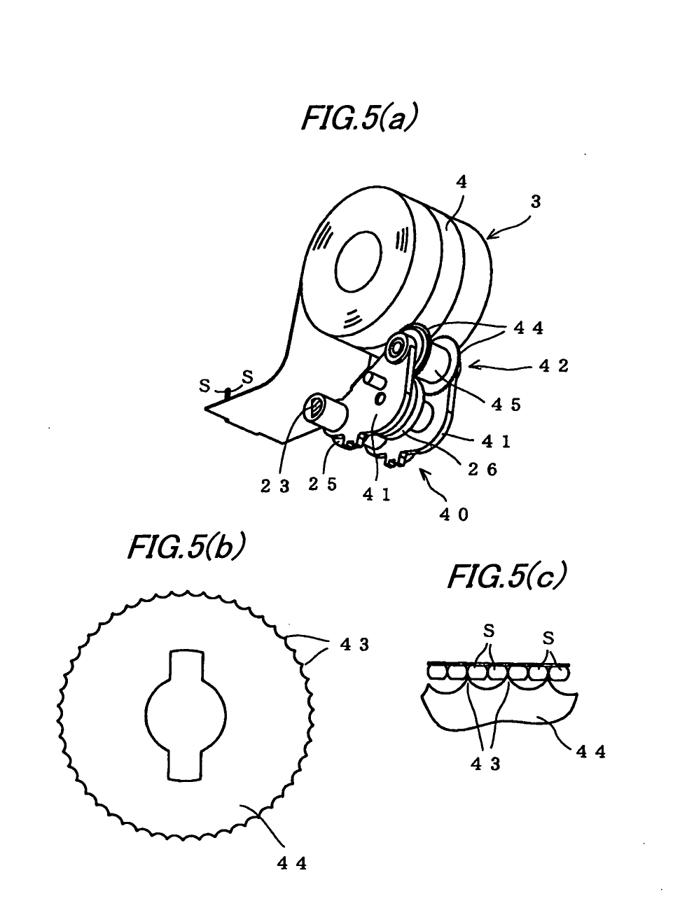

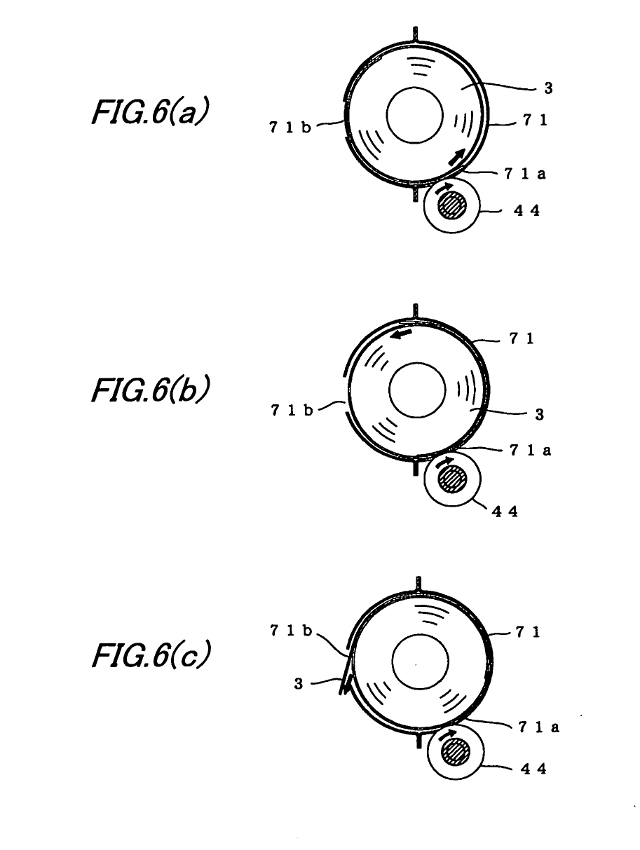

FIGS. 5 and 6 show a staple supplying unit 40 of the stapling apparatus A. FIG. 5(a) is a perspective view of the staple supplying unit. FIG. 5(b) is a front view of a feeding roller. FIG. 5(c) is a view for explaining the relationship between the feeding roller and staples. FIG. 6 is a view for explaining the rolled staple supplying operation by the feeding rolled in a time sequence.

The staple supplying unit 40 includes a pair of holding plates 41 through which the shaft 23 penetrates at their one ends; and a bobbin-like feeding roller 42 rotatably held between other ends of the holding plates 41. Incidentally, the holding plates 41 hold the internal interlocking gear 25 and internal gear 26 therebetween.

The feeding roller 42 includes a pair of roller members 44 of hard rubber with a large number of feeding teeth 43 on their outer peripheral faces and a feeding gear 45 located between the roller members 44 and to be in mesh with the internal gear 26.

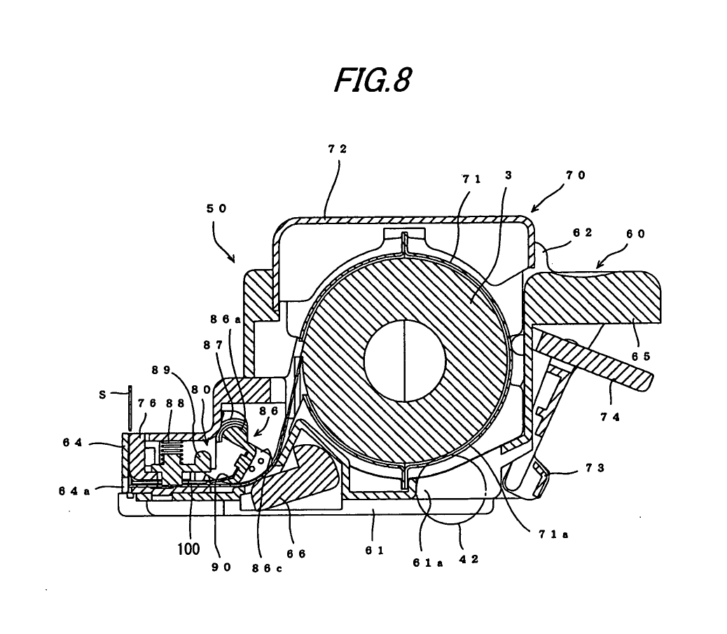

The feeding teeth 43 engage between alternately adjacent staples as seen from FIG. 5(c) for the outer peripheral face of a cylindrical rolled staple 3 composed of a large number of straight staples S coupled linearly and wound in a roll shape. Thus, as seen from FIG. 6, by only driving the normal/reverse driving motor 2 in the reverse direction, through the rotation of the roller members 44, the tip of the rolled staple 3 can be automatically fed in a pulling-out direction and guided/supplied to a staple supplying path 100 (see FIG. 8).

For this reason, easiness and certainty of maintenance in the replacement of the rolled staple 3 can be assured. Further, since the feeding teeth 43 are formed on the roller member 44 during staple supply, the rolled staple 3 can be supplied by a short supplying path. In addition, time-passage deterioration such as abrasion and slippage in feeding-out can be prevented, thereby improving reliability.

Incidentally, the feeding roller is not limited to that having the feeding tooth. The feeding roller may not have the feeding teeth.

### [Rolled Staple]

The rolled staple 3 is composed of a large number of staples S coupled by a bonding sheet which can be cut when the staple S at the forefront is separated from the subsequent staple S by the driver 34. In this case, the bonding sheet 4 is located outside when the staples S are wound in a roll shape. This is because if the bonding sheet 4 is located inside, it generates slack and the driver 34 ascends from below. Specifically, as described later, the bonding sheet 4 is located on the upper side of the staple S at the tip supplied by the roller members 44. Therefore, by causing the driver 34 to ascend from below, the fragment of the bonding sheet 4 being applied to the staple S after cutting is located between the staple S after stapling of the stapled sheets and the stapled sheet so that it is concealed from the outside.

### [Cartridge 50]

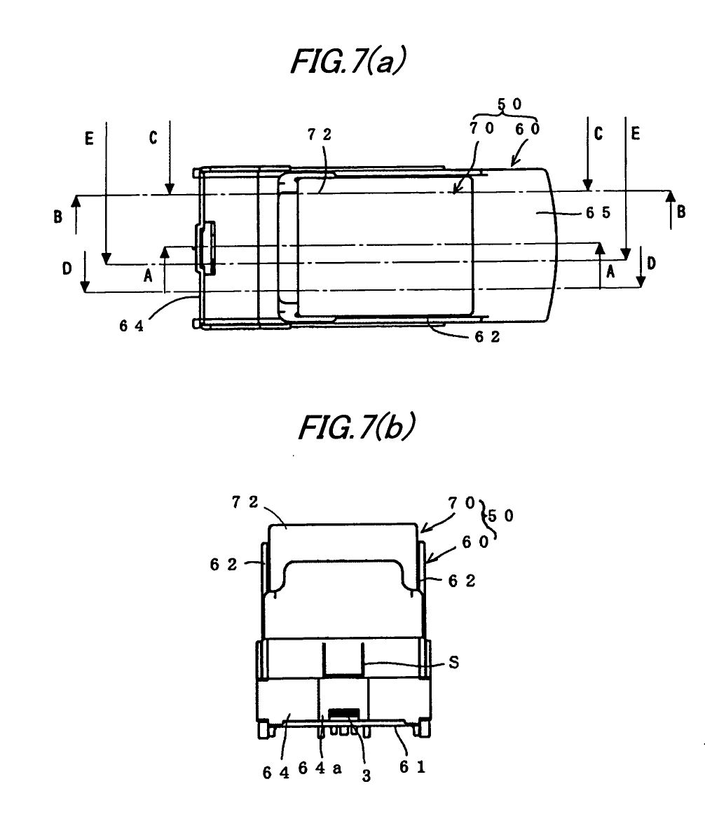

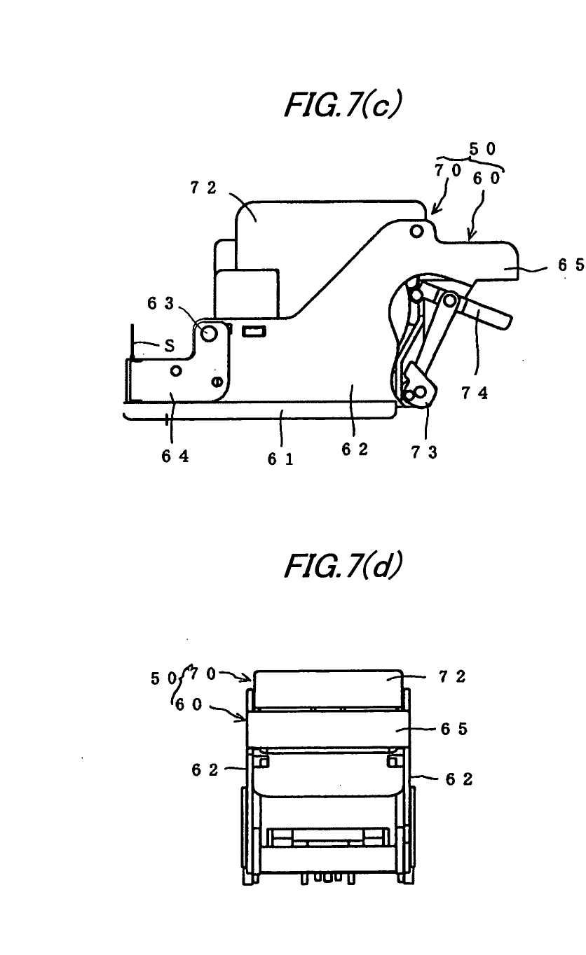

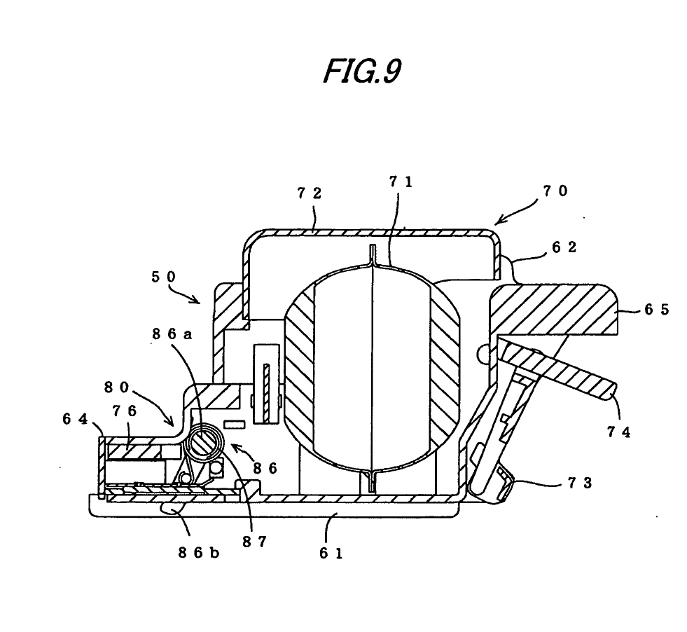

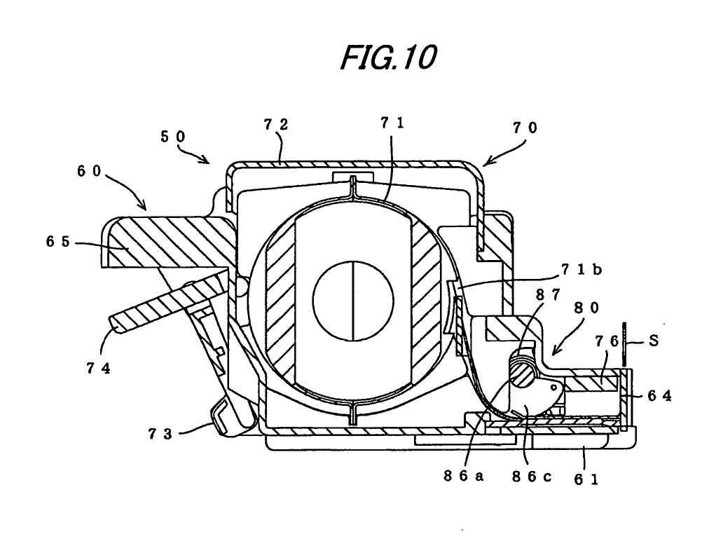

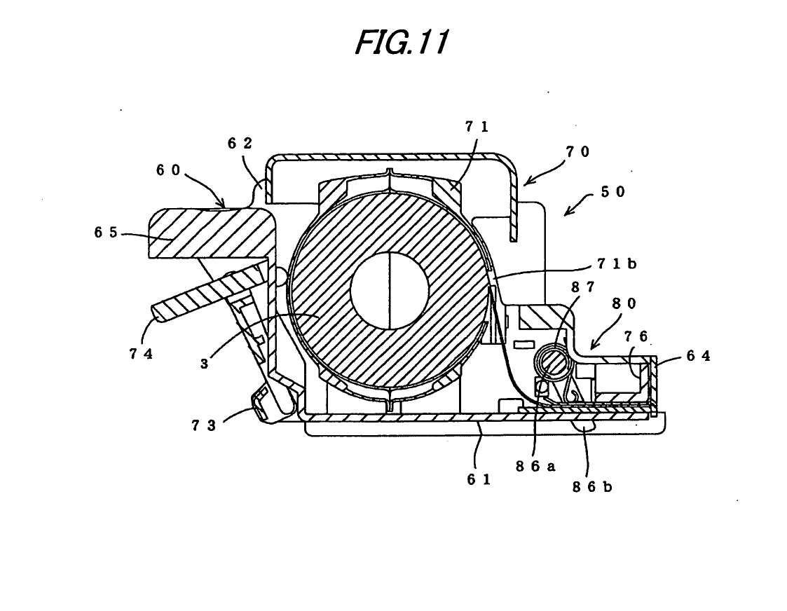

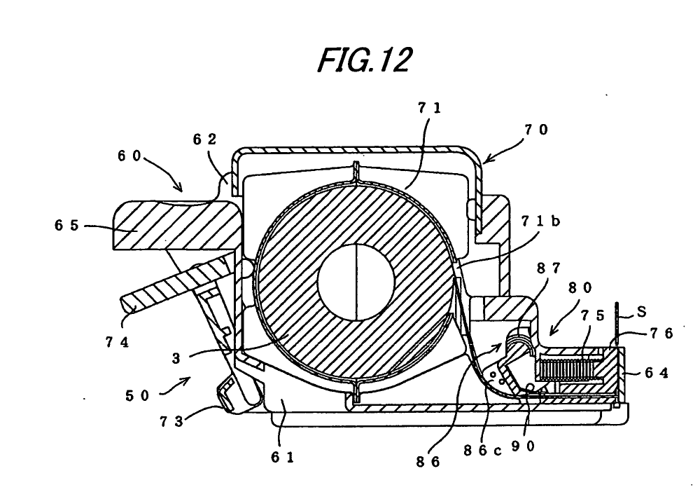

FIGS. 7 to 12 shows a cartridge 50. FIG. 7(a) is a plan view of the cartridge. FIG. 7(b) is a left side view of the cartridge. FIG. 7(c) is a front view of the cartridge. FIG. 7(d) is a right side view of the cartridge. FIG. 8 is a longitudinal sectional view of the cartridge taken in line A-A in FIG. 7(a). FIG. 9 is a longitudinal sectional view of the cartridge taken in line B-B in FIG. 7(a). FIG. 10 is a longitudinal sectional view of the cartridge taken in line C-C in FIG. 7(a). FIG. 11 is a longitudinal sectional view of the cartridge taken in line D-D in FIG. 7(a). FIG. 12 is a longitudinal sectional view of the cartridge taken in line E-E in FIG. 7(a).

The cartridge 50 is detachably housed in a housing area la (see FIGS. 1 and 3) opened toward above and one side of the main frame 1, and includes a sub-frame unit 60 and a housing unit 70 for housing the rolled staple 3.

### [Sub-Frame Unit 60]

The sub-frame unit 60 includes a base 61; a pair of sub-frames 62 upstanding from two opposite sides of the base 61 and detachably holding the housing unit 70; a face plate 64 having a nearly C-shape when viewed in plane, which is held at the tips of the sub-frames 62 to be rotatable at the fulcrum of the shaft 63; a hand-shaking piece 65 upstanding from the rear end of the base 61; a guide member 66 for guiding the rear side of the portion of the rolled staple 3 taken out from the housing unit 70 while bending it; and a feeding-out unit 80 for feeding out the range extending from the bent segment to the horizontal segment on the front side of the rolled staple 3.

The base 61 is provided with an opening 61a facing the feeding roller 42 at the rear end.

The face plate 64 is provided with a stopper 64a for stopping the tip of the rolled staple 3 at the lower end.

### [Housing Unit 70]

The housing unit 70 includes a holder 71 of resin for holding the rolled staple 3 by a mating structure of semi-halves; a cover 72 for covering the holder 71 from above; a locking operation member 74 which is grasped in cooperation with the hand-shaking piece 65 and provided with a locking piece 73 which holds the cartridge 50 in the main frame 1 in its engagement with a locking piece lb of the main frame 1; and a slider 76 urged toward the face plate 64 by a spring 75.

The holder 71 has an opening 71a facing the feeding roller 42 and an opening 71b from which the rolled staple 3 is taken out.

### [Feeding-out Unit 80]

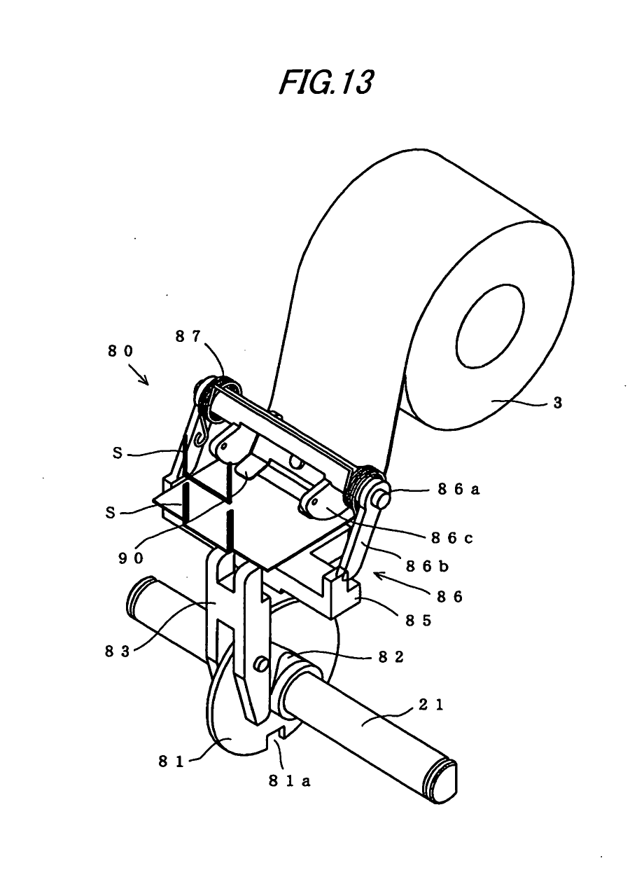

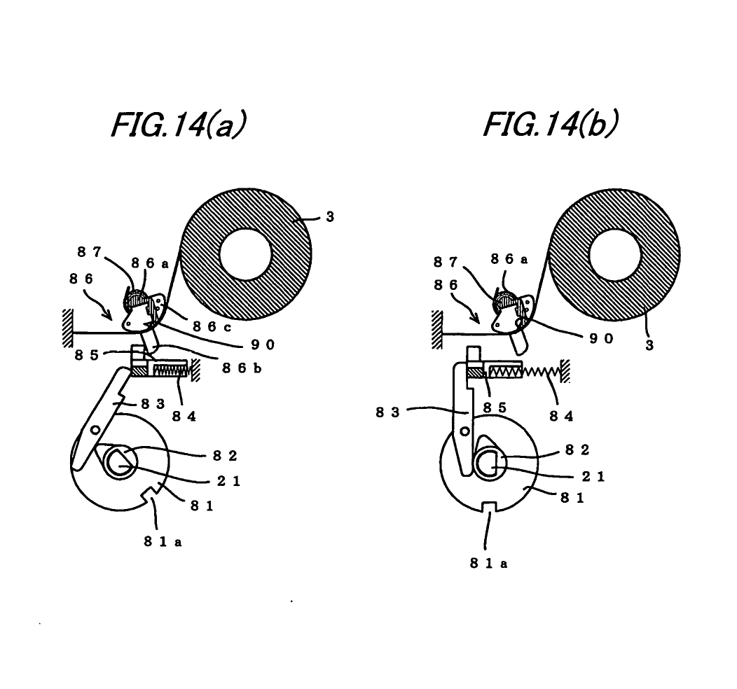

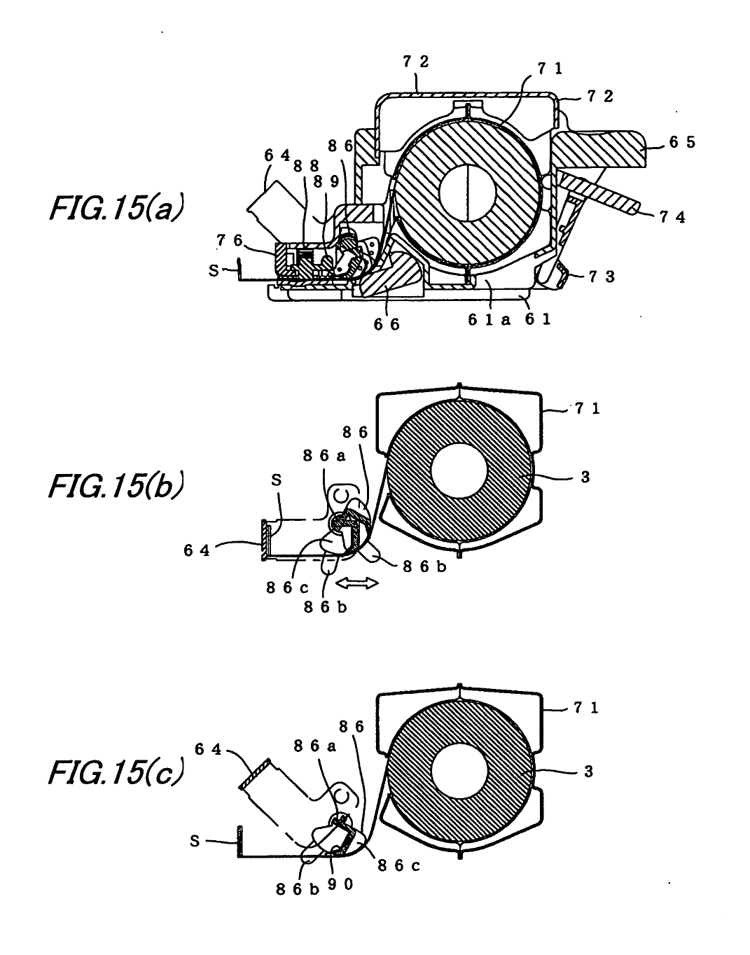

FIGS. 13 to 15 show a feeding-out unit employed for the stapling apparatus A using the cartridge 50. FIG. 13 is a perspective view of the main part of the feeding-out unit 80. FIG. 14 is a view for explaining the operation of the feeding-out unit 80. FIG. 15(a) is a view for explaining the operation in taking out a staple S in a feeding-out unit 80.

The feeding-out unit 80 includes, on the side of the main frame 1 side, a reference position plate 81 fixed to the shaft 21; a cam 82 fixed to the shaft 21; a rotating link 83 which is rotated by the cam 82; and a slider 85 retraced against the urging force by the spring 84 by the rotation of the rotating link 83. Further, the feeding-out unit 80 includes an arm member 86 which is rotated by the progress/retrace motion of the slider 85; springs 87 whose urging is set so as to rotate the arm member 86 in the staple feeding direction; and a backlash preventing die member 89 for pressing the tip side of the rolled staple 3 toward the base 61 through the urging by the spring 88(see FIG. 8).

The reference position plate 81 has a reference position detected segment 81a formed at a portion thereof. Thus, only when the position of the reference position detected segment 81a is detected by a position sensor, the reverse driving of the normal/reverse driving motor 2 is permitted. By switching the transmission path through the above rotating plate 18, switching can be made to the second operating state for an entirely different function in which during the normal rotation of the normal/reverse driving motor 2, the normal stapling operation is carried out, and during the reverse rotation of the normal/reverse driving motor 2, automated supply of the above rolled staple 3 and the posture change of the stapling apparatus A in staple replacement (the entire stapling apparatus A is turned in a backward or removal posture toward the side of opening the maintenance cover of the image forming apparatus). In this case, by causing the single rotation of the reference plate 81 to coincide with the stapling cycle, if the reference position is not detected, on the assumption that inferior stapling such as buckling of the staple S occurred, the reference plate 81 is rotated in the reverse direction so that it is restored to the reference position, and thereafter the normal/reverse driving motor 2 can be reversed.

The arm member 86 includes a shaft 86a on which the springs 87 are wound, arms 86b located at both ends of the shaft 86a and being in contact with a slider 85, arcs 86c centrally located on the shaft 86a and claws 90 attached to the arcs 86c.

The tips of the claws 90 are engaged between the staples S at the tip of the rolled staple 3, and rotate by the retrace of the slider 85 (see FIG. 14). Thereafter, they successively feeds out the staples so that whenever the forefront staple S is driven by urging by the springs 87, the subsequent staple S bumps against the stopper 64a of the face plate 64.

Therefore, in the normal feeding-out, the bent portion near the taking-out starting area of the rolled staple 3 to the horizontal portion thereof is taken as a cyclic range so that the staples can be fed out without making the carrying path of the rolled staple 3 completely linear. Thus, the carrying path of the rolled staple 3 can be shortened. Accordingly, the cartridge 50 and the stapling apparatus A can be downsized.

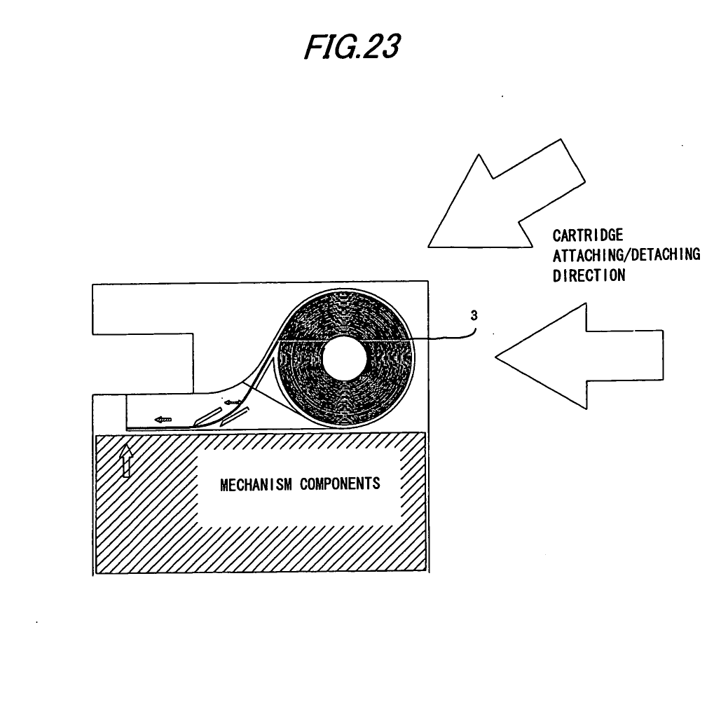

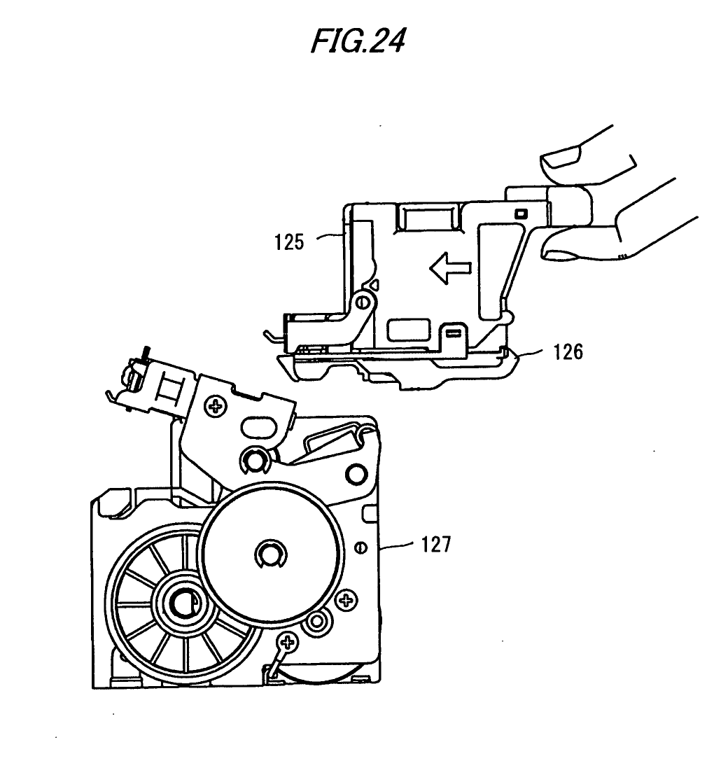

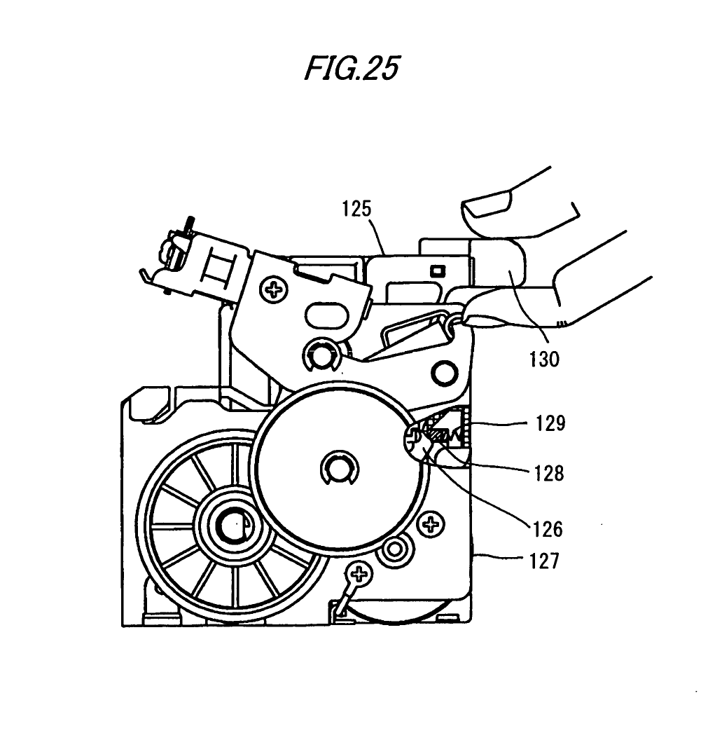

In short, in the arrangement relationship also as shown in FIG. 23, the staples are fed out by swinging the feeding claws to be engaged with the curved portion of the rolled staple, but not fed out through their straight reciprocating motion. Therefore, a large space is not required for staple feeding. As a result, the cartridge can be further downsized.

Further, in a state where the bonding sheet 4 when the staple S is driven into a bundle of sheets can be located between the bundle of sheets and the staple S, the rolled staple 3 is arranged at the rear upper side of the stapling apparatus A. Therefore, the driving systems for the normal/reverse driving motor 2 and driver 34 can be arranged front and behind below the rolled staple 3. In addition, the mechanism for feeding out the staples S and the clincher unit 32 are arranged in front of the rolled staple 3 can be arranged at the front upper side of the stapling apparatus A. Further, since a cassette can be loaded in plural directions, with the stapling apparatus A being miniaturized, the cartridge 50 can be inserted in the main frame 1 from above and rear, and can be easily handled. In addition, the maintenance of the cartridge 50 such as the replacement of the rolled staple 3 can be easily made, and the installing space of the stapling apparatus A for the narrow image forming apparatus can be assured and easily designed.

Further, the arms 86b are engaged with the face plate 64. Therefore, when the face plate 64 is lifted upward, the arm member 86 is pushed up to the front retraced position (FIG. 15(c)) so that the engagement of the staple S with the claws 90 is canceled.

Thus, when the staple S is driven, where inferior driving such as buckling of the staple S occurs, the feeding-out of the staple S by the claws 90 can be canceled in interlock with the lifting of the face plate 64. Accordingly, by once taking out the vicinity of the tip of the rolled staple 3 to the inferior portion, and taking up the remaining usable portion, the waste consumption of the rolled staple S can be prevented.

Meanwhile, in the above normal/reverse driving motor 2, by making the motor driving torque variable between during the normal rotation and reverse rotation, it is possible to prevent the inconvenience such as damage of a power transmission system owing to the application of too great load.

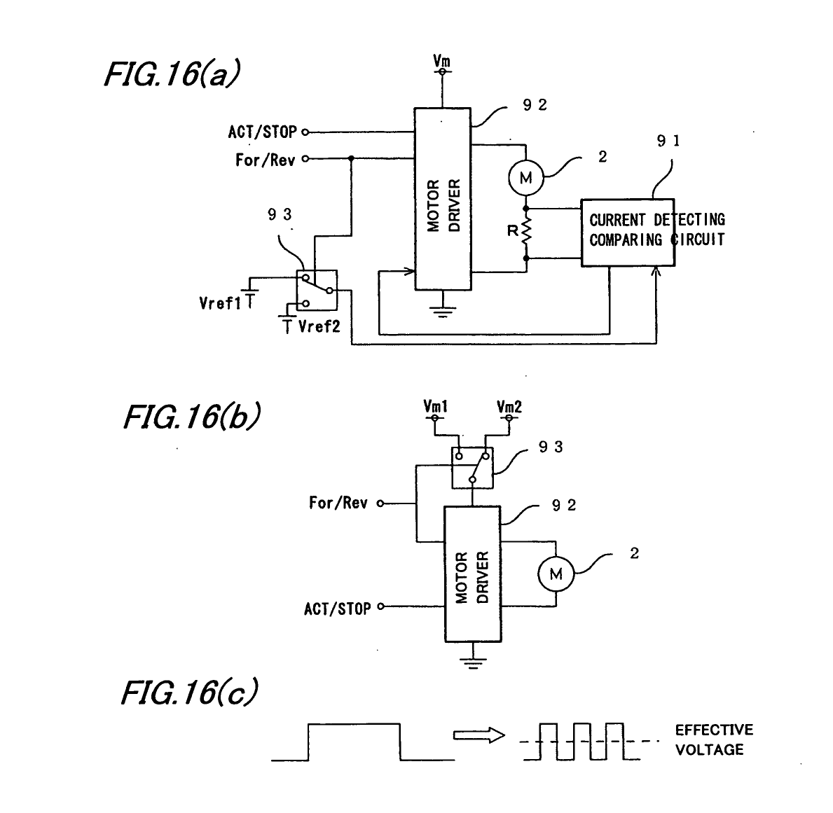

An example of the method for making the motor driving torque variable between during the normal rotation and during the reverse rotation is shown in FIGS. 16(a) to 16(c).

The circuit for making the motor driving torque variable as shown in FIG. 16(a) includes a current detecting/comparing circuit 91, a motor driver 92 for driving the normal/reverse driving motor 2 and a selective switch 93.

The current detecting/comparing circuit 91 detects the current flowing through a resistor R connected in series with the normal/reverse driving motor 2 in terms of the voltage across the resistor R. Thereafter, the current detecting/comparing circuit 91 compares the detected voltage compares a reference voltage (Vref1, 2) supplied thereto with the detected voltage, and supplies a voltage difference to “Free” of a motor driver 92.

On the basis of the voltage supplied to the Free, the motor driver 92 adjusts the current to be passed through the normal/reverse driving motor 2 so that the voltage supplied to the Free from the current detecting/comparing circuit 91 becomes 0 V, i.e. adjusts the current passing through the normal/reverse driving motor 2 so that the voltages across the resistor R are equal to the reference voltage.

Where the current flowing through the normal/reverse driving motor 2 is changed between during the normal rotation and the reverse rotation, two kinds of reference voltages are prepared, and by switching the selective switch 93, the reference voltages (Vref1, Vref2) for the normal rotation and the reverse rotation is selectively supplied to the current detecting/comparing circuit 91.

The circuit for making the motor driving torque variable as shown in FIG. 16(b) prepares two kinds of motor driving voltages themselves of the normal/reverse driving motor 2 which are switched between during the normal rotation and during the reverse rotation.

Further, FIG. 16(c) shows a circuit for making the motor driving torque variable in which as compared with the torque (e.g. 10 V) during the normal rotation, the torque during the reverse rotation is reduced to half thereof through the software control such as a pulse width modulation circuit.

### EMBODIMENT 2

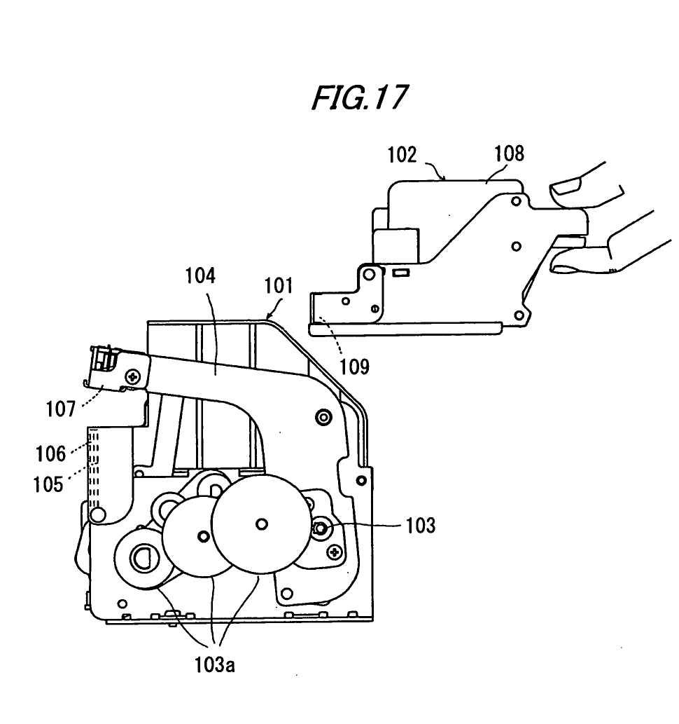

FIG. 17 is a schematic view of an electric stapler (stapling apparatus) according to a second embodiment of the present invention. The electric stapler includes an electric stapler body 101 and a cartridge 102 for stapling.

The electric stapler body 101 includes a driving link 104 which is swung in interlock with an output shaft 103 of the electric motor, a forming plate 105 which is driven by the force transmitted from the output shaft 103 through intermediate gears 103a, a driver plate 106, etc. The driver link 104 has a clincher 107 attached to its tip.

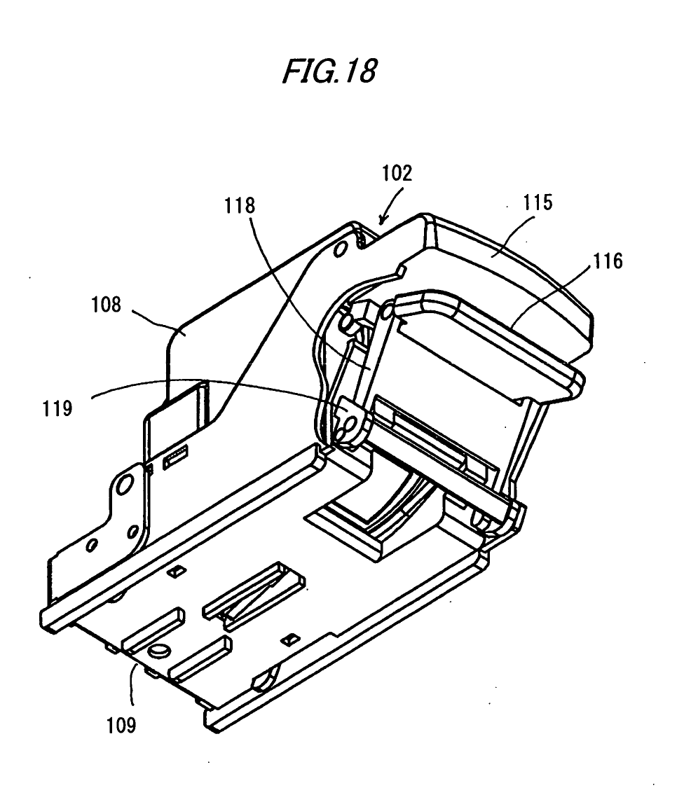

The cartridge 102, as seen from FIG. 18, includes a housing unit 108 in which a large number of straight staples are housed and a driving-out unit 109 for driving the staple discharged from the lower end of the housing unit 108. The housing unit 108 incorporates sheet-like staples (not shown) each composed of a large number of straight staples coupled to be a sheet, in a stacked manner.

After the cartridge 102 has been loaded in the electric stapler body 101, the sheet-like staples are fed in order from the lowest sheet-like staple to the side of a driving-out unit 109 by a feeding mechanism (not shown).

In this embodiment, the staples housed in the cartridge 102 are sheet-like staples, but the rolled staple adopted in the first embodiment may be housed in a cartridge 102 and fed to the driving unit 109 by the feeding mechanism such as the feeding roller.

The staples fed to the driving unit 109 are formed in a C-shape in order from the leading staple by the forming plate 105 driven by the above electric stapler body 101. Thereafter, the staple is driven by the driver plate 106 so that the legs of the staple penetrate through the sheets. Thereafter, the driving link 104 is operated so that the clincher 107 at its tip bends the staple legs, thus completing the stapling. Further, the driving link 104 and driver plate 106 are restored to their initial position so that the subsequent stapling is prepared.

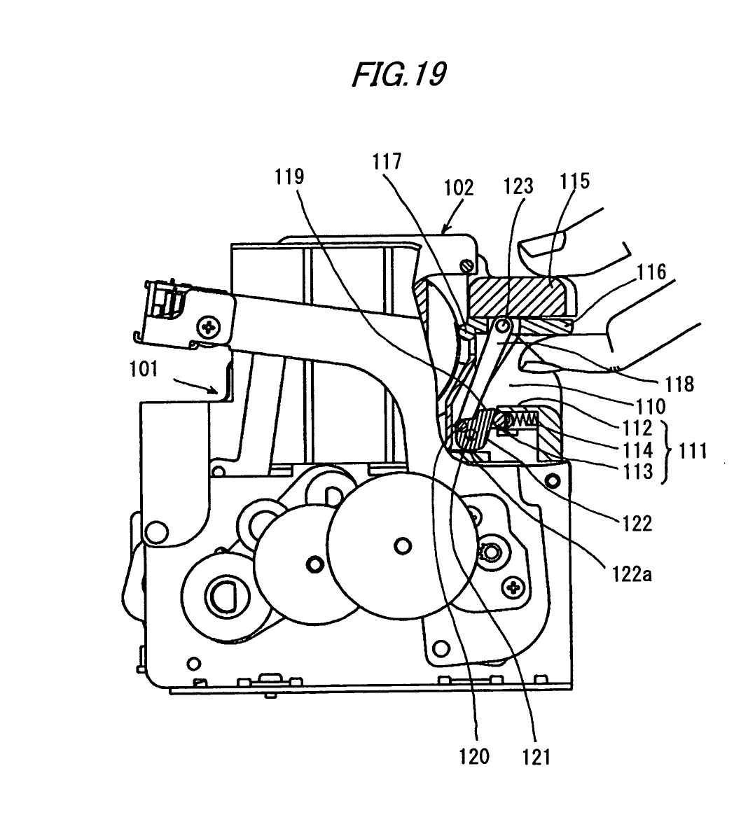

The electric stapler body 101 and cartridge 102, as seen from FIG. 19, are provided with a device for removing the cartridge 102. Specifically, the electric stapler body 101 has an attachment area 110 though which the cartridge 102 is loaded or unloaded. The attachment area 110 is formed as a space enough to house the cartridge 102. The attachment area 110 has locking pieces 111 formed at the lower portion on the opened side of the attachment area. The locking piece 111 has a structure in which a locking pin 113 within a cylinder 112 is urged by a spring 114 to normally protrude inward of the attachment area 110. The protruding degree of the locking pin 113 is suppressed to a constant quantity.

On the other hand, as shown in FIGS. 18 and 19 the cartridge 102 is provided with a knob 115 on the side opposite to the driving unit 109 and an operating lever 116 attached to the lower face of the knob 115. The operating lever 116 is located immediately below the base of the knob 115 so that it can be operated simultaneously with the knob 115 and rotated around a fulcrum 117. On each the left and right sides of the intermediate portion of the operating lever 116, the one end of an operating link 118 is attached rotatably around the shaft 123. To the other end of the operating link 118, an engagement die 119 serving as an engagement piece to be engaged with or disengaged from the above lock piece 111 is attached rotatably around a first shaft 120. The engagement die 119 is also rotatably attached to a second shaft 121 formed on each both side walls (not shown) of the cartridge 102. The engagement die 119 has a slope 122 formed so as to form an acute and obtuse angle with the extension of the bottom of the cartridge 102 (or bottom of the attachment 110 in the loaded state) before and after the rotation (before and after the operating lever 116 is pulled), respectively. The lower end of the slope 122 leads to a gentle arc 122a.

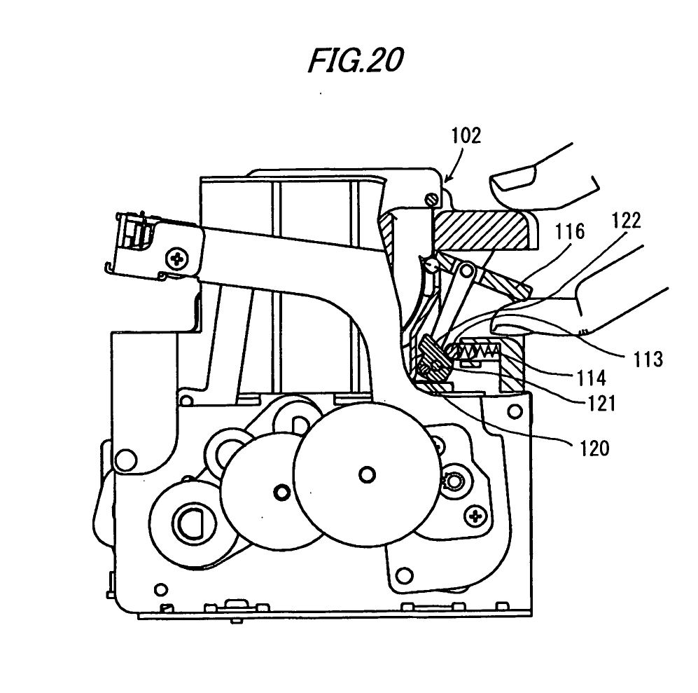

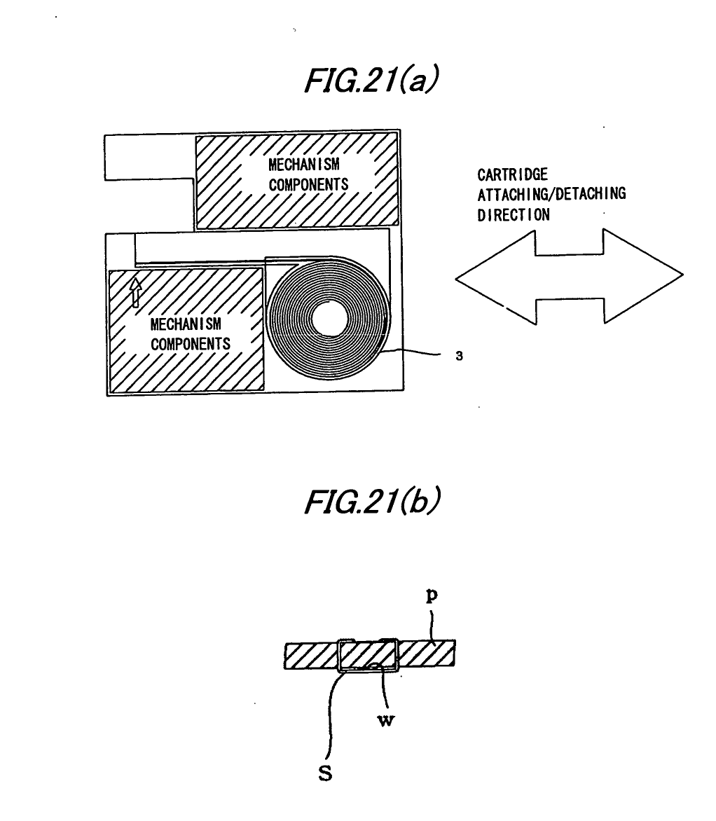

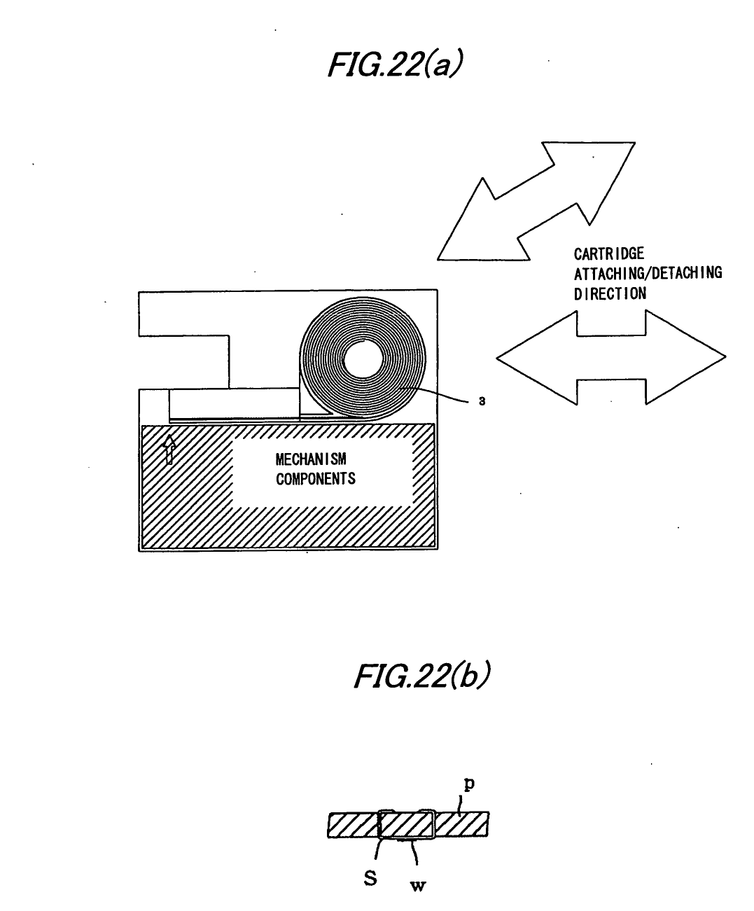

In loading the cartridge 102 in the electric stapler body 101, as seen from FIG. 19, with the operating lever 116 picked together with the knob 115 by one hand, the operating links 118 are pulled to rotate the engagement dies 119 around the second shaft 121 clockwise in FIG. 19. The slope 122 forms the acute angle with the bottom of the attachment area 110 in the state where cartridge 102 has been loaded so that it enters the attachment area 110 like a wedge, thereby intruding the locking pin 113 of the lock 111 against the spring 114. When the second shaft 121 passes over the protruding extension of the locking pin 113 so that the lower end of the engagement die 119 is brought into contact with the bottom of the attachment area 110, if the operator's hand is moved off the operating lever 116, as seen from FIG. 20, the locking pin 113 pushes the slope 122 of the engagement die 119 to be rotated counterclockwise. As a result, the slope 122 of the engagement die 119 forms the obtuse angle with the protruding direction of the locking pin 113. Thus, the slope 122 of the engagement die 119 is engaged with and locked by the locking pin 113 so that it serves as resistance against an pulling-out operation. Accordingly, since the cartridge 102 cannot be easily pulled out, the loaded state is stabilized. In addition, the driving unit 109 is located at the position corresponding to the forming plate 105 and driver plate 106 of the electric stapler. Thereafter, the stapling operation may be started.

On the other hand, where the loaded cartridge 102 is removed, in the manner reverse to the above operation, first, the operating lever 116 is pulled together with the knob 115. As seen from FIG. 19, the operating link 118 is lifted and the engagement die 119 is rotated clockwise. Thus, the slope 122 of the engagement die 119 forcibly pushes the locking pin 113 to form the acute angle with the extension of the bottom of the cartridge 102. In this state, if the cartridge 102 is rotated so that the knob 115 and operating lever 116 are separated from the cartridge attachment area 110 upward in the drawing, the slope 122 is forming the acute angle with the bottom of the attachment area 110 so that resistance owing to the engagement with the locking pin 113 is decreased. Thus, the engagement can be easily canceled so that the cartridge 102 can be smoothly and surely removed from the attachment area 110.

After the cartridge 102 has been removed, the operating lever 116 may be in a state adjacent to or separated from the knob 115. The engagement die 119 must be rotated when the cartridge 102 is loaded in the stapler body 101, and it is removed after loading. At the time of loading and removing, the cartridge 102 is rotated by pulling the operating lever 116 together with the knob 115, and after loading the cartridge 102 can be rotated by the elastic force of the locking pin 113 by the spring 114. Therefore, the means such as a spring for rotating the engagement die 119 is not required.

The present invention has been hitherto described in detail and with reference to the specific embodiments, but it is apparent to those skilled in the art that the present invention can be changed or modified in various manners without departing from the spirit and scope of the present invention.

This application is based on Japanese Patent Applications, i.e. Japanese Patent Appln. No. 2003-406407 filed on Dec. 4, 2003; Japanese Patent Appln. No. 2004-032661 filed on Feb. 9, 2004; Japanese Patent Appln. No. 2004-032662 filed on Feb. 9, 2004; and Japanese Patent Appln. No. 2004-032663 filed on Feb. 9, 2004, and the contents of which are incorporated herein by reference.

### INDUSTRIAL APPLICABILITY

As understood from the description hitherto made, in accordance with the present invention, management of the tip position of the rolled staple in manufacturing the cartridge and the manufacture itself do not time and labor, and good productivity is also given.

1. A stapling apparatus comprising:
a feeding roller in contact with a peripheral face of a rolled staple composed of a large number of straight staples linearly coupled to form a roll shape; and
a driving motor that drives the feeding roller,
wherein the feeding roller rotates the rolled staple in a pulling-out direction so that a tip of the rolled staple is supplied to a staple supplying path.

2. The stapling apparatus according to claim 1, wherein the feeding roller comprises a plurality of feeding teeth formed on a peripheral face of the feeding roller and facing between adjacent staples of the rolled staple.

3. A stapling apparatus comprising:
a cartridge in which a rolled staple composed of a larger number of straight staples linearly coupled on a bonding sheet and wound in a roll shape so that the bonding sheet is located outside, and a tip of the staples of the rolled staple is guided in a state curved toward a side opposite to a roll-winding direction; and
a feeding claw swingably attached to the cartridge and engaged with a curved portion of the rolled staple to guide the staples in a pulling-out direction.

4. The stapling apparatus according to claim 3, wherein the feeding claw is disengaged from the rolled staple when the tip of the rolled staple is manually pulled out.

5. A stapling apparatus comprising:
a driving motor rotatable in a normal and a reverse direction;
a gear unit composed of a plurality of gears that transmits a driving power of the driving motor;
a switching gear that is located on a way of the gear unit and switches a power driving path between two directions;
a first driving system that executes stapling by normal rotation driving of the driving motor when the switching gear is engaged with one power transmission system; and
a second driving system that executes an operation other than the stapling by reverse driving of the driving motor when the switching gear is engaged with the other power transmission system.

6. The stapling apparatus according to claim 5, further comprising:
a reference position detecting unit attached to an end of the first driving system, wherein
only when the reference position detecting unit detects a reference position, the reverse driving of the driving motor is continued.

7. The stapling apparatus according to claim 6, wherein one driving cycle of the first driving system is synchronous with a detecting timing of the reference position detecting unit;
if the reference position detecting unit does not detect the reference position as a result that inconvenience occurs during the one driving cycle of the first driving system, the driving cycle of the first driving system is corrected so that when the reference position detecting unit detects the reference position, the driving motor is driven in a reverse direction.

8. The stapling apparatus according to claim 5, wherein driving torque is variable between during normal rotation and during reverse rotation of the driving motor.

9. The stapling apparatus according to claim 8, further comprising:
a detecting means for correcting a driving voltage value during the normal rotation and reverse rotation on the basis of two kinds of reference voltages for the normal rotation and reverse rotation of the driving motor.

10. The stapling apparatus according to claim 8, further comprising:
a high voltage supplying unit for the normal rotation of the driving motor;
a low voltage supplying unit for the reverse rotation of the driving motor; and
a selective switch for switching the supplying path according to the normal/reverse rotation of the driving motor.

11. The stapling apparatus according to claim 8, wherein the driving voltage of the driving motor is switched by pulse width modulation.

12. A stapling apparatus comprising:
an attachment area formed in a stapler body into which a cartridge is intruded;
an engagement piece attached to the cartridge;
a locking piece formed in the attachment area and engageable with the engagement piece;
a knob attached to the cartridge and to be grasped in attaching or detaching; and
an operating lever attached to the cartridge and to be employed to cancel engagement between the engagement piece and the locking piece,
wherein the knob and the operating lever are simultaneously grasped to cancel the engagement.

13. The stapling apparatus according to claim 12, further comprising:
an operating link rotatably attached to an intermediate portion of the operating lever; and
an engagement die rotatably attached to the tip of the operating link so that it is engaged with the locking piece when the operating lever is released.
